(19) United States
(12) Patent Application Publication
(10) Pub. No.: US 2014/0054999 A1
(43) Pub. Date: Feb. 27, 2014

(54) METHOD OF MANUFACTURING AN ELECTRIC MACHINE WITH SEGMENTED PERMANENT MAGNETS

(71) Applicants: David Fulton, Anderson, IN (US); Bradley D. Chamberlin, Pendleton, IN (US)

(72) Inventors: David Fulton, Anderson, IN (US); Bradley D. Chamberlin, Pendleton, IN (US)

(73) Assignee: REMY TECHNOLOGIES, LLC, Pendleton, IN (US)

(21) Appl. No.: 13/595,704

(22) Filed: Aug. 27, 2012

(51) Int. Cl. H02K 15/03; H02K 1/27

(52) U.S. Cl. CPC H02K 15/03; H02K 1/274
USPC 310/156.38; 29/598

(57) ABSTRACT

A method for manufacturing a magnet stack for placement in a core member of a permanent magnet electric machine includes providing a plurality of magnet segments, each of the plurality of magnet segments including opposing axial faces having a first surface finish. The method further includes assembling the plurality of first magnet segments into a magnet stack, the magnet stack including a first end with a first axial face of a first magnet segment and an opposing second end with a second axial face of a second magnet segment. Additionally, the method includes finishing the opposing ends of the magnet stack such that the first axial face and the second axial face have a second surface finish that different than the first surface finish.

### FIELD

This application relates to the field of electric machines, and particularly electric machines having permanent magnets.

### BACKGROUND

Interior permanent magnet machines have been widely used as driving and generating machines for various applications, including driving machines for hybrid electric vehicles, and generating machines for internal combustion engines. Internal permanent magnet (IPM) electric machines have magnets positioned in the interior of the rotor. Typically, each magnetic pole on the rotor is created by inserting permanent magnet (PM) material into multiple slots formed in the laminated stack of the rotor. The slots commonly extend in the axial direction for the entire length of the laminated stack.

Various design strategies are common in the design of permanent magnet motors. One common design strategy involves the use of segmented magnets in each rotor slot. Permanent magnet motors have eddy current losses in the magnets due to time-varying magnetic fields passing through the magnets. One method of minimizing these losses in each magnet positioned in a rotor slot is to divide the magnet into multiple segments in the axial direction with insulation between each magnet segment. This results in a stack of insulated magnet segments positioned in each slot of the rotor. The insulation between the magnet segments greatly reduces eddy current losses in the magnetized material in each slot. This principle is similar to the minimization of iron losses in the electric machine by using laminated steel structures in motor stators and rotors.

Another design strategy common in the design of permanent magnet motors concerns the axial length of the magnet. In particular, with internal permanent magnet motors (i.e., magnets inside the rotor lamination stack), it is desirable to make the total magnet axial length very close to, but not longer than, the length of the rotor lamination stack. This allows the maximum amount of magnet material to used in the rotor (providing maximum torque density), without interfering with balance rings on the ends of the rotor lamination stack. Also, for rare earth permanent magnets, any permanent magnet material protruding axially beyond the ends of the lam stack is poorly utilized for producing useful flux. Consequently, excess permanent magnet length is costly and wasteful. A tight tolerance on the total magnet axial length is necessary to give consistent performance characteristics from one motor to the next.

When stacks of axially segmented magnets are positioned in internal permanent magnet motors, the conventional manufacturing process involves grinding or otherwise machining each magnet segment to precise dimensions prior to assembly of the magnet stack and insertion of the magnet stack into the slot. This process includes the two design strategies described above. Unfortunately, this process is costly and time consuming as each magnet segment must be manufactured and finished within precise tolerances. Accordingly, it would be advantageous to provide a method for manufacturing an electric machine where the individual segmented permanent magnets are more easily produced. Moreover, it would be advantageous the segmented permanent magnets and magnet stacks in a cost efficient manner.

While it would be desirable to provide a method of manufacturing a permanent magnet electric machine that provides one or more of the above or other advantageous features as may be apparent to those reviewing this disclosure, the teachings disclosed herein extend to those embodiments which fall within the scope of the appended claims, regardless of whether they accomplish one or more of the above-mentioned advantages.

### SUMMARY

In accordance with at least one embodiment of the disclosure, a method is provided for manufacturing a rotor for a permanent magnet electric machine. The method comprises providing a plurality of coarse magnet segments and assembling the plurality of coarse magnet segments into a magnet stack. The magnet stack includes opposing ends defined in an axial direction. After the magnet stack is assembled, the opposing ends of the magnet stack are ground to a desired surface finish. The magnet stack is then inserted into the rotor.

In accordance with another embodiment of the disclosure an electric machine comprises a stator with a rotor opposing the stator. A plurality of axial slots are provided in the rotor. A plurality of magnet stacks are positioned in the plurality of axial slots in the rotor. Each of the plurality of magnet stacks includes a plurality of coarse magnet segments positioned between two opposing ends. Each of the plurality of coarse magnet segments includes at least one axial face having a first surface finish. Each end of the magnet stack includes a ground end face having a second surface finish, the first surface finish being substantially different from the second surface finish.

In accordance with yet another embodiment of the disclosure a method is provided for manufacturing a magnet stack for placement in a core member of a permanent magnet electric machine. The method comprises providing a plurality of magnet segments, each of the plurality of magnet segments including opposing axial faces having a first surface roughness. The method further comprises assembling the plurality of first magnet segments into a magnet stack, the magnet stack comprising a first end including a first axial face of a first magnet segment and an opposing second end including a second axial face of a second magnet segment. Additionally, the method comprises finishing the opposing ends of the magnet stack such that the first axial face and the second axial face have a second surface roughness that different than the first surface roughness.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a partial view of an electric machine including a stator and a rotor core member with internal permanent magnets;

FIG. 2 shows a perspective view of a the rotor core member with internal permanent magnets of FIG. 1;

FIG. 3 shows a perspective view of an exemplary permanent magnet before it is separated into a plurality of magnet segments;

FIG. 4 shows a perspective view of a magnet stack comprised of a plurality of magnet segments, the magnet stack configured for insertion into the rotor core member of FIG. 2;

FIG. 5A shows adjacent axial faces on two coarse magnet segments of the magnet stack of FIG. 4;

FIG. 5B shows the adjacent axial faces of FIG. 5A with an insulation sheet provided between the adjacent axial faces;

FIG. 6A shows a plurality of coarse magnet segments for the magnet stack of FIG. 4, each coarse magnet segment including an axial face with an intended surface feature in the form of protuberances on the axial face;

FIG. 6B shows plurality of coarse magnet segments for the magnet stack of FIG. 4, each coarse magnet segment including an axial face with an intended surface feature in the form of a concave surface;

FIG. 6C plurality of coarse magnet segments for the magnet stack of FIG. 4, each coarse magnet segment including an axial face with an intended surface feature in the form of a convex surface;

FIG. 6D shows a plurality of coarse magnet segments for the magnet stack of FIG. 4, each coarse magnet segment including an axial face with an intended surface feature in the form of a wavy surface; and

FIG. 7 shows a flow chart of a method for manufacturing an electric machine including the magnet stack of FIG. 4.

### DESCRIPTION

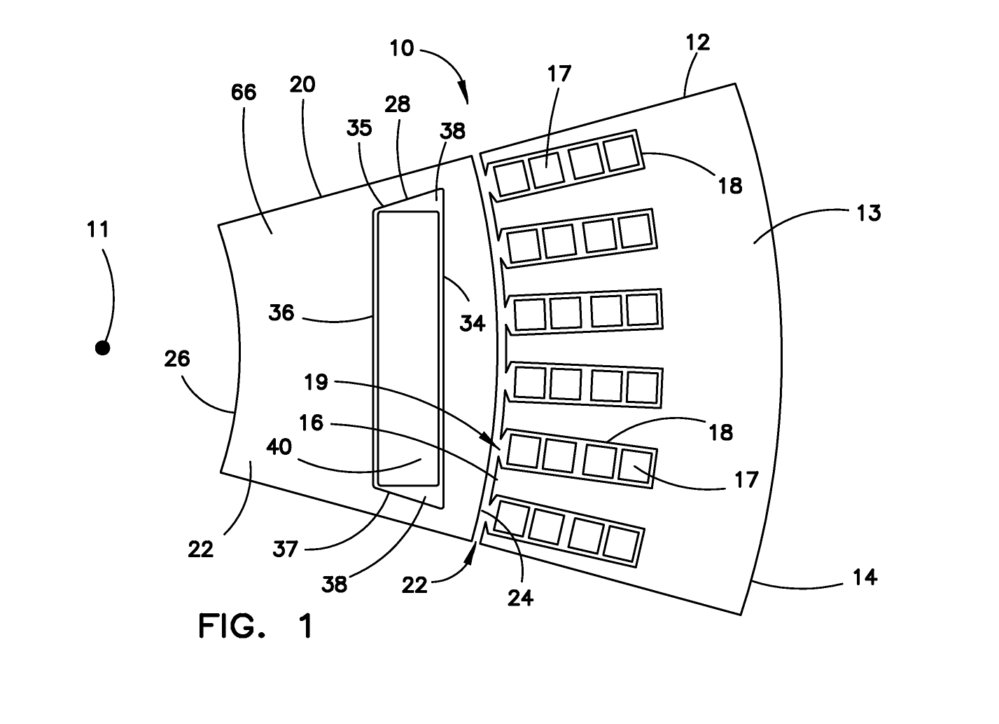

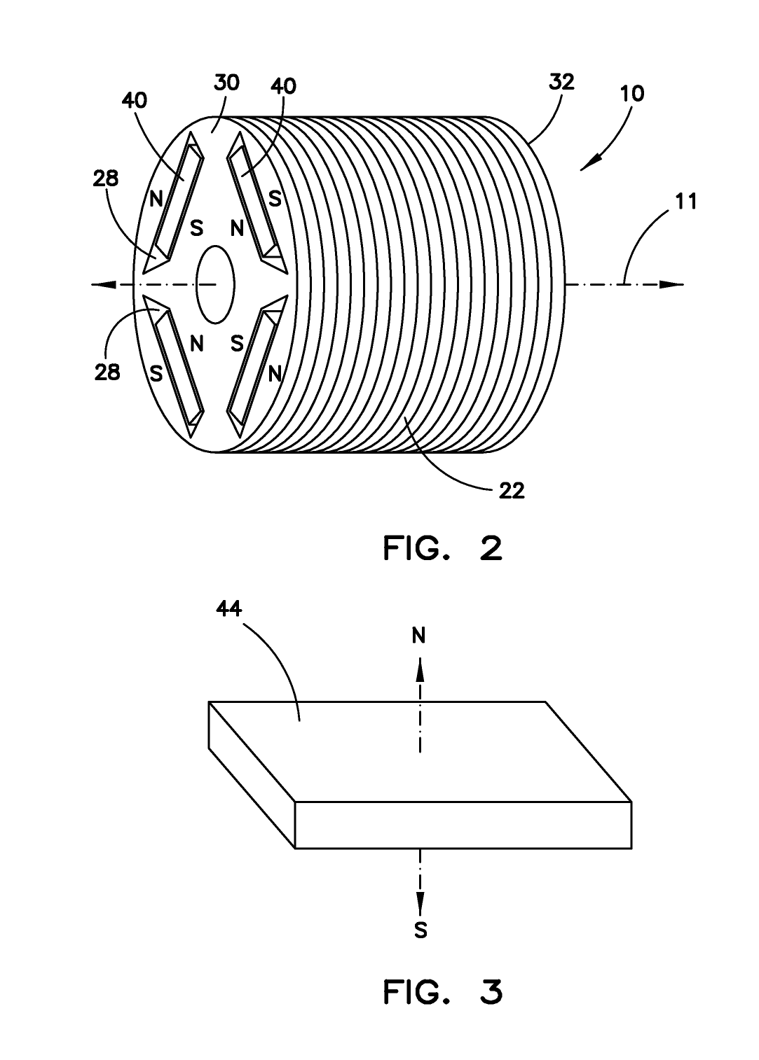

With reference to FIGS. 1 and 2, a partial view of an electric machine is shown. The electric machine 10 comprises a stator 12 and a rotor 20 opposing the stator 12. A plurality of slots 28 are formed in the rotor 20, each of the plurality of slots is configured to hold a permanent magnet stack 40. It will be appreciated that FIG. 1 shows only about 30° of the rotor and stator arrangement which actually extends 360° to form a complete circular arrangement.

With continued reference to FIG. 1, the stator 12 includes a core member 13. The core member 13 may be comprised of a laminated stack of sheets of ferromagnetic material, such as sheets of silicon steel. The core member 13 is generally cylindrical in shape and extends along a rotor axis 11. The core member 13 includes a substantially circular outer perimeter 14 and a substantially circular inner perimeter 16. The inner perimeter 16 forms a cavity within the stator 12 that is configured to receive the rotor 20. Slots 18 are formed in the core member 13 of the stator 12. These slots 18 are designed and dimensioned to receive conductors 17 that extend in the axial direction through the stator slots 18. In the embodiment of FIG. 1, the slots 18 are partially open slots such that small openings 19 to the slots 18 are provided along the inner perimeter 16 of the stator. The conductors 17 are placed in the winding slots 18 to form windings for the electric machine on the stator.

The rotor 20 includes a core member 22 including a plurality of slots 28 with the magnet stacks 40 positioned in the plurality of slots 28. As shown in FIG. 1, the rotor 20 is designed and dimensioned to fit within in the inner cavity of the stator 12 such that the circular outer perimeter 24 of the rotor 20 is positioned opposite the circular inner perimeter 16 of the stator 12. A small air gap 22 separates the stator 12 from the rotor 20. In at least one alternative embodiment which is generally opposite to that of FIG. 1, the rotor 20 could be positioned outside of the stator 12, as will be recognized by those of ordinary skill in the art.

The rotor core member 22 is comprised of laminated sheets of ferromagnetic material, such as sheets of steel. The rotor core member 22 is generally cylindrical in shape and includes a substantially circular outer perimeter 24 and a substantially circular inner perimeter 26. As will be recognized by those of ordinary skill in the art, the inner perimeter 26 of the rotor is coupled to a rotor shaft (not shown) that delivers a torque output for the electric machine 10.

The slots 28 in the rotor core member 22 extend in the axial direction from a first end 30 to an opposite second end 32 of the rotor core member 22. The slots 28 are generally trapezoidal in cross-sectional shape, with each slot 28 including two elongated sides 34, 36 and two shorter sides 35, 37. The two elongated sides include a stator side 34 and an opposing side 36. The stator side 34 of the slot 28 is positioned closer to the stator 12 than the opposing side 36. Accordingly, the stator side 34 of the slot 30 generally opposes the outer perimeter 24 of the rotor and the opposite side 36 of the slot 30 generally opposes the inner perimeter 26 of the rotor. The shorter sides 35, 37 extend between the ends of the elongated sides 34, 36 in a generally radial direction on the core member 22.

The magnet stacks 40 are snugly positioned in the slots 28 of the rotor core member 22. As explained in further detail below, each magnet stack 40 includes a plurality of segmented permanent magnets. The magnet stacks 32 in the embodiment of FIG. 1 are generally cuboid/rectangular in shape. Each magnet stack 32 fills a substantial portion of the associated slot 28, with empty slot portions 38 provided along the side of the slot 28. These empty slot portions 38 may remain as voids in the slots 28 or be filled by non-ferromagnetic materials, such as nylon. The magnet stacks 40 have a direction of magnetization in the radial direction. Accordingly, one magnet pole faces the stator side 34 of the slot 28 and an opposite magnet pole faces the inner side 36 of the slot. As shown by the “N” and “S” markings in FIG. 2, the pole facing the stator alternates between magnet stacks when moving around the rotor.

The magnet stacks 40 are comprised of a plurality of magnet segments 42 that are cohered together to form a unitary component. Each of the plurality of magnet segments 42 includes opposing axial faces 46, and each axial face includes a surface that is substantially perpendicular to the rotor axis 11 when the associated magnet stack 40 is placed in the rotor core member 22. Magnet segments 42 may be formed in different manners. In at least one embodiment, the magnet segments 42 are formed by taking a relatively large permanent magnet 44, as shown in FIG. 3, and cutting or otherwise separating the magnet 44 into a plurality of coarse magnet segments 42. In another embodiment, the magnet segments 42 are die formed or molded separate from other magnet segments. The term “coarse magnet segment” as used herein refers to a magnet segment that has been formed by any of various processes for use in a magnet stack of a permanent magnet electric machine, but the axial faces of the magnet segment have not been finish machined such as finish ground or finish polished in order to provide a substantially smooth and flat surface on the axial faces. For example, in one embodiment, a “coarse magnet segment” includes magnet segments having a first surface roughness on the axial face where the average roughness, Rₐ (expressed in units of height), is greater than 6.3 μm (i.e., millionths of a meter). In such embodiment, a magnet segment that has been removed of burrs following cutting, but none of the axial faces have been finish ground, finish polished, or otherwise finish machined such that the surface roughness on the axial faces remains greater than 6.3 μm would be considered a “coarse magnet segment”.

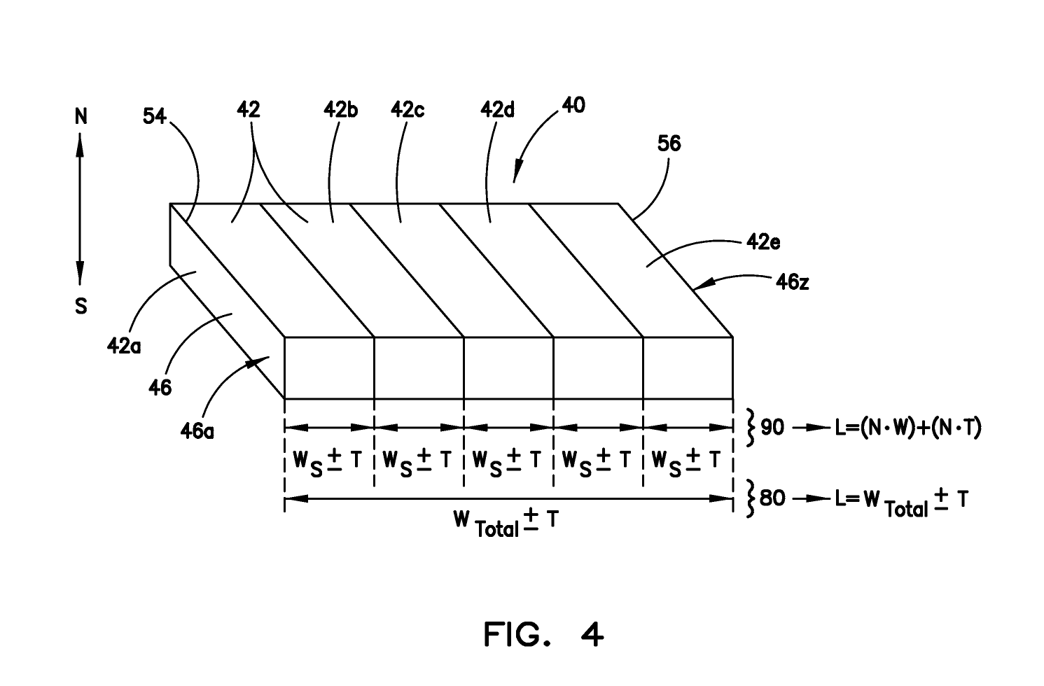

With continued reference to FIG. 4, coarse magnet segments 42 are positioned next to each other in the magnet stack 40. Any two magnet segments 42 positioned next to each other in a magnet stack 40 may be referred to herein as “adjacent magnet segments”. Adjacent magnet segments will include adjacent axial faces. Insulation is provided between adjacent axial faces of the adjacent magnet segments 42 to reduce eddy current losses in the magnetized material in each slot 28. The insulation between the adjacent axial faces may include thin polymer sheets, oxide films, adhesive material, or a substantially non-electrical conducting coating. Moreover, the insulation between the adjacent magnet segments may consist of air pockets between the adjacent axial faces. The air pockets are generally formed by burrs, surface irregularities, intended surface features, or other structures that separate at least portions of adjacent axial faces.

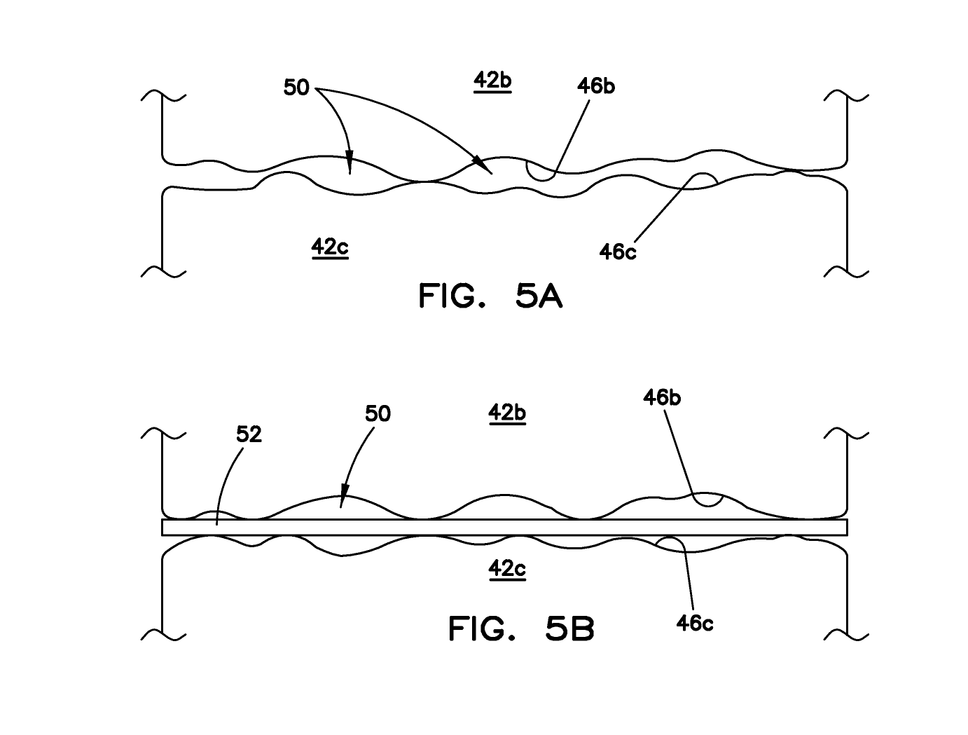

FIG. 5A shows two adjacent axial faces 46b and 46c on two adjacent magnet segments 42b and 42c. Air pockets 50 are formed between the axial faces 46b and 46c. As described above, these air pockets provide insulation between the magnet segments 42b and 42c, thus reducing eddy current losses in the magnet stack 40 during operation of the electric machine 10. FIG. 5B shows an alternative embodiment where additional insulation layer 52 in the form of a polymer sheet is also provided between the magnet segments 42b and 42c along with the air pockets 50.

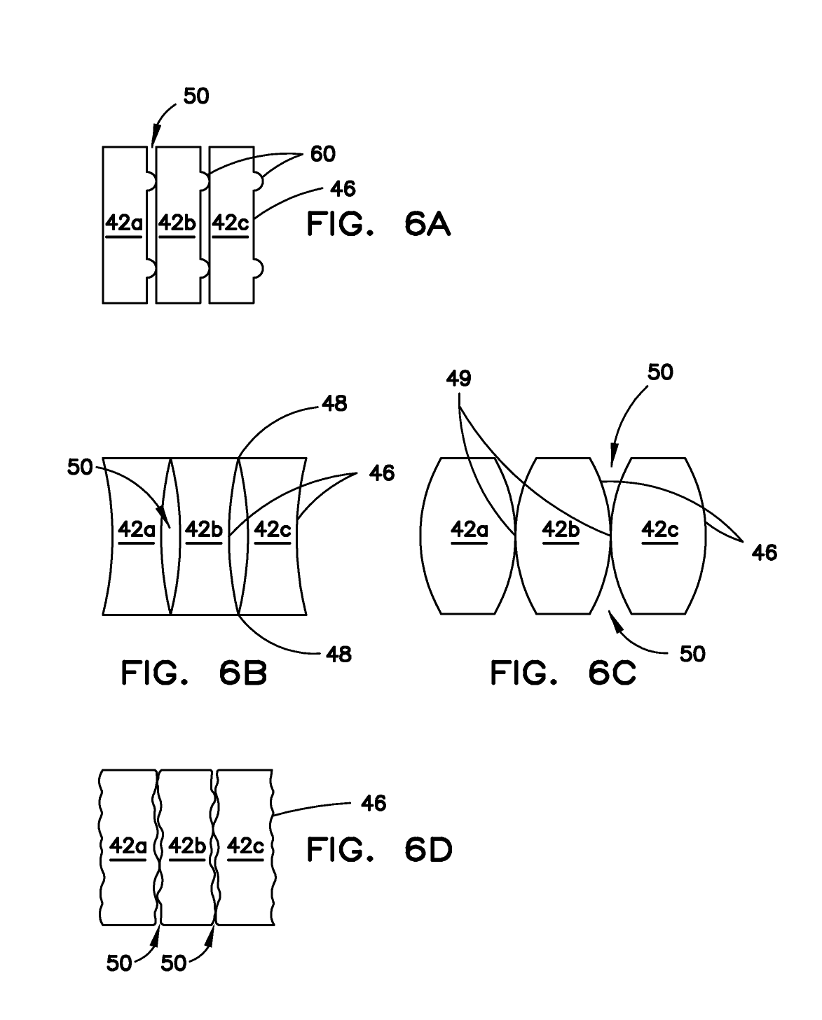

With reference now to FIG. 6A-6C, the air pockets 50 between the axial faces (e.g., 46b and 46c) on adjacent magnet segments (e.g., 42b and 42c) may be provided in a number of different ways. In a first embodiment, shown in FIG. 6A, separation between the axial faces 46 are provided by one or more protrusions 60 formed on the axial face. Each protrusion 60 is provided by an intended surface feature that is purposely formed in each magnet segment in order to allow air pockets to be formed between adjacent magnet segments. The protrusion 60 may be a knurl, hemisphere, post, or any other component that extends away from the main portion of the axial face 46 such that an adjacent axial face is spaced apart from the main portion of the axial face by the protrusion, and therefore air pockets 50 are formed between the adjacent axial faces.

In another embodiment shown in FIG. 6B, at least one axial face 46 of each magnet segment is concave in shape. Accordingly, air pockets 50 are formed between the axial faces 46, as adjacent axial faces only touch at the end portions 48 of the axial faces 46. Again, the concave shape of each axial face 46 is an intended surface feature that is purposely formed in order to allow air pockets to be formed between adjacent axial faces.

The embodiment of FIG. 6C is similar to that of FIG. 6B, but in the embodiment of FIG. 6C the intended surface features are convex axial faces 46. Accordingly, adjacent convex axial faces 46 touch near a center portion 49 of each axial face, but do not touch on the end portions 48 such that air pockets 50 are formed at the end portions 48 of the adjacent axial faces 46.

The embodiment of FIG. 6D is similar to that of FIG. 5A. In this embodiment, the axial faces 46 include relatively rough or wavy surfaces. These rough or wavy surfaces may be provided naturally during the manufacturing process, or may be intended surface features that are purposefully included during formation of the magnet segments 42.

With reference again to FIG. 4, each magnet stack 40 includes two opposing ends 54 and 56. Each opposing end 54, 56 of the magnet stack 40 includes an axial end face 46a and 46z. The axial end faces 46a and 46z are finish ground such that the magnet segments 42a and 42b are no longer coarse magnet segments. However, the magnet segments 42 positioned between the end magnet segments 42a and 42b remain coarse magnet segments, as the axial faces of these magnet segments have not been finish ground or polished. Accordingly, the magnet segments 42 between the magnet segments 42a and 42b include a first surface finish, and the magnet segments 42a and 42b on the opposing ends 54 and 56 of the magnet stack 40 include a second surface finish with a surface roughness (Rₐ) that is substantially different from the first surface finish. For example, the first surface finish may have a surface roughness (Rₐ) that is greater than 6.3 μm, such as between 6.3 μm and 20 μm. Meanwhile, the second surface may be significantly smoother than the first surface finish. For example, the second surface finish may have a surface roughness (Rₐ) on the axial end faces 46a and 46z that is less than 6.3 μm, such as between 1.0 and 6.3 μm.

The air pockets between the axial faces of the coarse magnet segments 42 described above are capable of providing sufficient insulation to result in reductions in eddy current losses because magnet segments do not need to be perfectly insulated in order to yield significant reductions in eddy current losses. In fact, it has been determined that even nominally insulated magnet segments 42 can achieve comparable benefits to that of perfectly insulated magnet segments. Accordingly, the air pockets between the coarse magnet segments 42 described above provide this nominal insulation and significantly reduce eddy current losses. While prior magnet stacks 40 have been formed by finish machining (e.g., finish grinding) each magnet segment to precise dimensions prior to assembly of the magnet stack 40, the magnet stacks described above provide essentially equivalent functional effects by using coarse magnet segments 42, assembling the coarse magnet segments 42 into a magnet stack 40, and then finish machining the assembled stack. This significantly reduces machining time and axial tolerance of the total magnet axial length.

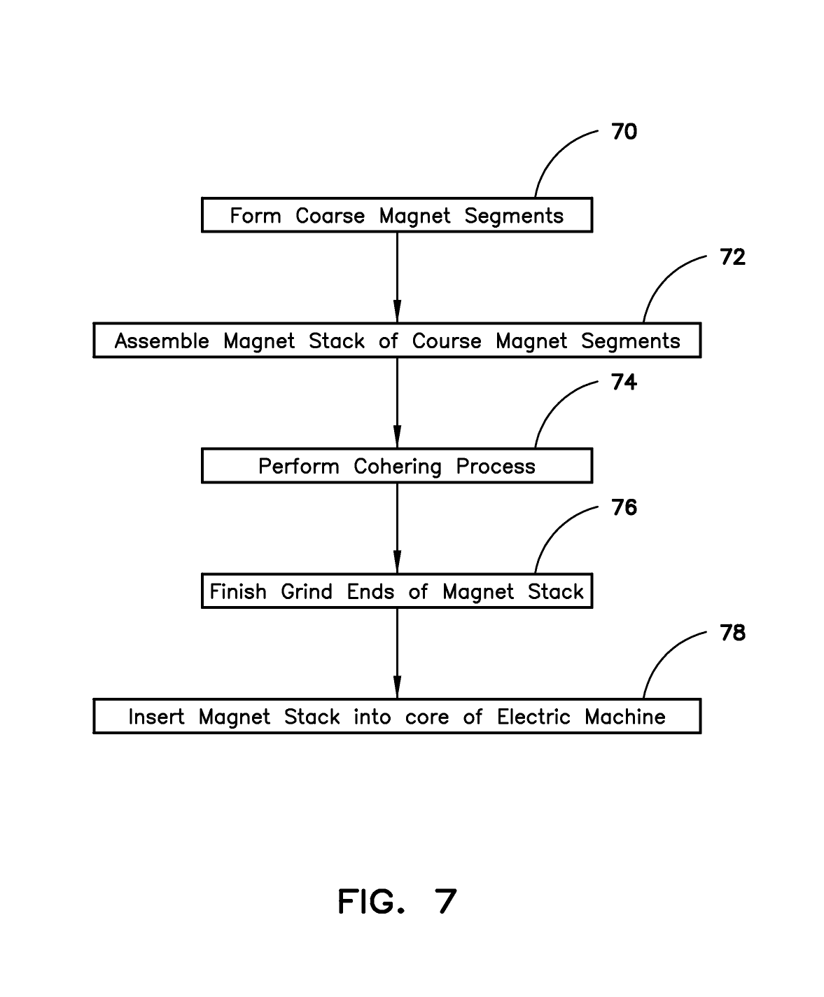

With reference now to FIG. 7, a method of manufacturing a rotor for an electric machine is described. The method begins with the formation of individual magnet segments, as shown in block 70. The gross shape of each magnet segment is determined during the formation process. As mentioned previously, magnet segments may be formed by any of various processes as will be recognized by those of skill in the art. For example, the magnet segments may be formed by making a long magnet and then cutting the long magnet into shorter magnet segments, which are coarse-toleranced dimensionally. As another example, magnet segments may be formed by pressing magnetic material into a die or molding magnetic material to form a magnet segment. Formed magnet segments may or may not be sintered afterwards. The magnet segments formed in step 70 are coarse magnet segments that have not been finish ground or polished. Accordingly, the axial faces on each of these coarse magnet segments will have a first surface roughness with a relatively high surface roughness. For example, the axial faces on these coarse magnet segments may have a Rₐ value that is well in excess of 6.3 μm.

Next, as shown in block 72, the formed magnet segments are assembled into a magnet stack. The magnet stack includes a first end and an opposing second end. The first end includes a first axial end face provided by a first magnet segment. The second end includes a second axial face provided by a second magnet segment. As discussed previously, insulation may be provided between adjacent magnet segments. This insulation may be provided in any of various forms. For example, magnet segments may be insulated by using thin polymer sheets, adhesive, oxide films, or a non-electrically conductive coating. The insulation may also be provided by shaping the axial faces of the magnet segments with intended surface features so as to create small air spaces between adjacent magnet segments. As described above with reference to FIGS. 6A-6D, exemplary intended surface features include axial protrusions as well as slight convex or concave shapes. Alternatively, or in addition, the axial faces may be impressed with other features that create small air space between adjacent segments, such as a grid or a wavy surface. Moreover, because the magnet segments remain coarse magnet segments that have not been finish ground or polished, burrs on the axial faces may provide further spacing between the adjacent axial faces.

After the magnet segments are assembled in a magnet stack (or in conjunction with this step), the magnet stack is subjected to a cohering process, as shown in block 74 of FIG. 7. The cohering process is designed to cause the coarse magnet segments of the magnet stack to become a coherent component that is unitary such that all magnet segments remain together on the stack. One exemplary cohering process may include overmolding the coarse magnet segments with an epoxy or other potting material. Another exemplary cohering process may include hot-melting adhesive layers between the magnet segments to form the magnet stack as a unitary component. In this embodiment, the cohering process of step 74 is performed in association with step 72 during assembly of the magnet stack. In yet another embodiment, the cohering process may include sintering the completely assembled magnet stack.

As shown in block 76, after the magnet stack is assembled and cohered, the magnet stack is finished by finish machining the magnet stack in all dimensions including the first end and the second end of the magnet stack. This machining process includes finish machining the first axial end face provided by the first magnet segment on the first end of the magnet stack (e.g., axial end face 46a). As a result, the first axial end face has a second surface roughness that is substantially different from the first surface roughness on the axial faces of the remaining coarse magnet segments in the magnet stack. Additionally, the machining process includes finish machining the second axial end face provided by the second magnet segment on the opposing second end of the magnet stack (e.g., axial end face 46z). As a result, the second axial end face also has a second surface roughness that is substantially different from the first surface roughness on the axial faces of the remaining coarse magnet segments in the magnet stack. For example, the axial end faces may have a Rₐ value that is substantially less than 6.3 μm. Moreover, the first and second axial end faces (e.g., 46a and 46z) are ground such that the length of the magnet stack fits into a slot of the rotor with the axial end faces flush with the rotor end faces, within a small tolerance. Thus, as illustrated in FIG. 4, following the process of block 76, the magnet stack axial dimension tolerance (illustrated by measurement 80) is that of a single machining operation (i.e., a machining operation on the two opposing axial end faces), and not that of the accumulated stack-up tolerance of all magnet segments (illustrated by measurement 90), as is common with prior magnet stack assembly processes.

With continued reference to FIG. 7, following finish machining of the magnet stack, the magnet stack is inserted into a core member of an electric machine, as shown in block 78. For example, the magnet stack may be inserted into a slot 28 of a rotor 20, as shown in FIG. 1. Once inserted into the slot, the first end and the second end of the magnet stack 40 are substantially flush with the associated first end and second end faces 66 of the rotor. Additionally, because the magnet stack axial dimension tolerance is only that of a single machining operation, the end faces of the magnet stack 40 are more consistently flush with the axial end faces of the rotor 20.

Again, one difference between the method of manufacturing magnet stacks shown in FIG. 7 and prior art methods for manufacturing magnet stacks is illustrated in FIG. 4 with respect to the two measurements 80 and 90. According to prior art methods illustrated by measurement 90, each individual magnet segment 42 was finish ground to precise dimensions prior to assembly into the magnet stack. In this case 90, each magnet 42 in the magnet stack 40 was ground to a width, wₛ, with a fine tolerance of +/−T. The magnet stack 42 was then assembled and the total length, L, of this magnet stack was equal to the number of segments, N, times the widths, w, with the total tolerance of the resulting magnet stack being the number of segments, N, times the fine tolerance, T (i.e., L=N×(wₛ+/−T); or stated differently, L=(N×wₛ)+/−(N×T). Thus, according to prior methods of assembly, the total accumulated tolerance of the magnet stack 40 increased with each additional magnet segment 42 included in the magnet stack (i.e., N×T). The large accumulated tolerance with these magnet stacks resulted in some magnet stacks falling outside of acceptable total tolerance range for the magnet stack. Magnet stacks that exceeded the acceptable tolerance had to be re-ground, while magnet segments that were less than the acceptable tolerance had to be disposed of. While this method resulted in magnet stacks with an acceptable axial length that were designed to reduced eddy current losses, the method of production of the magnet stacks was expensive.

In contrast to prior art methods, the method for manufacturing magnet stacks for use in a permanent magnet electric machine as described with reference to FIG. 7 significantly reduces these expenses by avoiding the need to finish grind or otherwise machine the axial faces of all the magnet segments. Instead, only the axial end faces of the assembled magnet stack should be ground according to the method described herein. As illustrated by measurement 80, the total length of the magnet stack is W_{Total}+/− a single tolerance T that results following the single machining operation. This single machining operation not only reduces the cost to assemble the magnet stack, but also provides for insulation between the magnet segments 42 as a result of the naturally occurring air pockets between the adjacent axial faces (e.g., 46b and 46c). This naturally occurring insulation provides the manufacturer with the option to not include other insulation such as polymer sheets between the adjacent axial faces of the magnet stack. As a result, the method for manufacturing an electric machine with interior permanent magnets as described herein offers significant advantages over the prior art.

Although the electric machine with segmented permanent magnets and method of making the same has been described with respect to certain preferred embodiments, it will be appreciated by those of skill in the art that other implementations and adaptations are possible. Moreover, there are advantages to individual advancements described herein that may be obtained without incorporating other aspects described above. Therefore, the spirit and scope of the appended claims should not be limited to the description of the preferred embodiments contained herein.

What is claimed is:

1. A method of manufacturing a rotor for a permanent magnet electric machine, the method comprising:
providing a plurality of coarse magnet segments;
assembling the plurality of coarse magnet segments into a magnet stack, the magnet stack including opposing ends defined in an axial direction;
machining the opposing ends of the magnet stack; and
inserting the magnet stack into the rotor.

2. The method of claim 1 wherein providing the plurality of coarse magnet segments comprises forming each of the plurality of coarse magnet segments using a die or a mold.

3. The method of claim 2 wherein forming each of the plurality of coarse magnet segments includes forming an intended surface on feature on at least one axial face of at least one of the plurality of coarse magnet segments, the at least one intended surface feature designed and dimensioned to allow for insulative material to be provided between axial faces of two adjacent coarse magnet segments in the magnet stack.

4. The method of claim 3 wherein the intended surface feature includes at least one protuberance on the at least one axial face.

5. The method of claim 3 wherein the intended surface feature includes a convex or concave surface on the at least one axial face.

6. The method of claim 1 wherein providing the plurality of coarse magnet segments comprises dividing a long magnet into a plurality of shorter magnet segments.

7. The method of claim 1 wherein the magnet stack includes insulative material between each of the plurality of coarse magnet segments in the magnet stack.

8. The method of claim 7 wherein assembling the plurality of coarse magnet segments into a magnet stack comprises placing an insulative material on each of the plurality of coarse magnet segments such that the insulative material is positioned between each of the plurality of coarse magnet segments following assembly of the magnet stack.

9. The method of claim 8 wherein the insulative material is a polymer sheet or an adhesive coating.

10. The method of claim 7 wherein the insulative material is air.

11. The method of claim 1 further comprising performing a cohering process on the magnet stack prior to machining the opposing ends of the magnet stack, the cohering process designed to cause the coarse magnet segments of the magnet stack to become a coherent component.

12. The method of claim 11 wherein the cohering process comprises sintering the magnet stack or overmolding the magnet stack.

13. The method of claim 1 further comprising machining walls of the magnet stack extending between the opposing ends.

14. The method of claim 1 wherein the magnet stack is inserted into a slot of a rotor lamination stack.

15. An electric machine comprising:
a stator;
a rotor opposing the stator;
a plurality of axial slots provided in the rotor; and
a plurality of magnet stacks positioned in the plurality of axial slots in the rotor, each of the plurality of magnet stacks including a plurality of coarse magnet segments positioned between two opposing ends, each of the plurality of coarse magnet segments including at least one axial face having a first surface roughness, each opposing end of the magnet stacks including at least one axial end face having a second surface roughness, the first surface roughness being substantially different from the second surface roughness.

16. The electric machine of claim 15 wherein at least one of the plurality of the coarse magnet segments includes an intended surface feature the at least one axial face, the intended surface feature separating a substantial portion of an adjacent axial face of another magnet segment.

17. The electric machine of claim 16 further comprising insulative material positioned between the adjacent axial faces.

18. A method of manufacturing a magnet stack for placement in a core member of a permanent magnet electric machine, the method comprising:
providing a plurality of magnet segments, each of the plurality of magnet segments including axial faces having a first surface roughness;
assembling the plurality of first magnet segments into a magnet stack, the magnet stack comprising a first end including a first axial end face on one magnet segment and an opposing second end including a second axial face of another magnet segment; and
finishing the first end and the second end of the magnet stack such that the first axial end face and the second axial end face have a second surface roughness that is substantially different than the first surface roughness.

19. The method of claim 18 further comprising inserting the magnet stack into the core member of the permanent magnet electric machine.

20. The method of claim 18 wherein the first surface roughness is greater than 6.3 μm and the second surface roughness is less than 6.3 μm.
